(19) United States
(12) Patent Application Publication
(10) Pub. No.: US 2010/0099806 A1
(43) Pub. Date: Apr. 22, 2010

(54) Process for Producing Dimethyl Carbonate Containing Compositions

(75) Inventors: Eric C. Houze, Mullica Hill, NJ (US); Laura Ann Lewin, Greenville, NJ (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington (DE)

(21) Appl. No.: 12/604,144

(22) Filed: Oct. 22, 2009

Related U.S. Application Data
(60) Provisional application No. 61/196,987, filed on Oct. 22, 2008.

(51) Int. Cl. C08K 5/04

(52) U.S. Cl. 524/280

(57) ABSTRACT

The present invention is directed to a process for producing compositions containing dimethyl carbonate alone or in combination with other co-solvent and more particularly directed to low VOC coating compositions used in automotive refinish applications.

### FIELD OF INVENTION

The present invention is directed to compositions containing dimethyl carbonate and more particularly directed to coating compositions directed to automotive refinish applications containing low VOCs (volatile organic compounds).

### BACKGROUND OF INVENTION

Many types of coating compositions, such as those used in the Industrial OEM (original equipment manufacturer) and automotive refinish market utilize liquid coatings that contain organic solvents some of which upon evaporation in the atmosphere can, depending upon the content of VOCs, be harmful to the environment and health. Generally VOCs are considered to be those organic chemical compounds that have high enough vapor pressures under normal conditions to significantly vaporize and enter the atmosphere, and to be photochemically reactive, leading to the formation of trophospheric ozone. Thus, the manufacturers of coating compositions endeavor to reduce the content of organic solvents in their compositions. Alternatively, the manufacturers of coating compositions employ certain solvents, such as acetone, methyl acetate, Oxsol® 100 (1-chloro, 4-trifluoromethyl benzene) and t-butyl acetate, which have been considered exempt VOC solvents by the United States Environmental Protection Agency. However, each of these exempt solvents has significant issues in coatings formulations. Acetone and methyl acetate are extremely volatile, limiting the amount that can be used in a given formula and t-butyl acetate is not accepted as VOC exempt by all Air Quality Management Districts (e.g., California does not accept t-butyl acetate as a VOC exempt solvent) and is also unstable in some coatings formulations. Oxsol® 100 is a very poor coatings solvent due to its high specific gravity (1.34) and weak solubility characteristics, so it is very expensive to use. Thus, a need still exists for a VOC-exempt solvent more suitable for use in coating compositions, such as industrial and automotive refinish paints that has a lower vapor pressure than acetone and methyl acetate and is also an effective solvent compatible with various components, such as binder component, of a typical coating composition.

### STATEMENT OF INVENTION

The present invention is directed to a process for producing a composition consisting essentially of a binder component and a solvent component, said process comprising the steps of:

(A) preparing the solvent component by mixing a solvent dimethyl carbonate with a co-solvent selected from the group consisting of aromatic hydrocarbon (135-146C), aromatic hydrocarbon (150-190C), aromatic hydrocarbon (182-219C), aliphatic hydrocarbon (100-150C), aliphatic hydrocarbon (100-163C), aliphatic hydrocarbon (115-149C), aliphatic hydrocarbon (138-177C), aliphatic hydrocarbon (138-185C), aliphatic hydrocarbon (145-205C), aliphatic hydrocarbon (150-205C), aliphatic hydrocarbon (150-210C), aliphatic hydrocarbon (155-190C), aliphatic hydrocarbon (170-210C), aliphatic hydrocarbon (180-210C), aliphatic hydrocarbon (182-266C), aliphatic hydrocarbon (90-110C), mineral spirit, 1,1,1-trichloroethane, 1,1,2-trichloroethane, 1,2-propylene glycol, 1,3-butanediol, 1,4-butanediol, 1-butoxy ethoxy 222-propanol, 1-methyl naphthalene, 1-nitro propane, 2,4-pentane dione, 2-ethyl hexanol, 2-ethyl hexyl acetate, 2-methyl-1-butanol, acetic anhydride, butyl acetate, di-isoamyl ketone, diacetone alcohol, diethylene glycol monobutyl ether acetate, diethylene glycol, diisobutyl ketone, ethylene glycol monoethyl ether acetate, glycol monopropyl ether acetate benzyl alcohol, 1,2-dichloroethane, 1,3-dioxane, 1,2-dimethoxyethane, 1-butanol, 1-methyl-2-pyrrolidinone, 1-propanol, 2-butanol, 2-ethylhexanol, 2-methoxyethanol, 2-propanol, acetone, acetonitrile, benzene, bis(2-methoxyethyl)ether, butyl cellosolve, carbon tetrachloride, chlorobenzene, chlorobenzene, cyclohexane, cyclohexanol, cyclohexanone, dibasic ester, dichloromethane, diethyl ether, diethylene glycol monobutyl ether, diisopropyl ether, dimethyl ether, dimethylpropyleneurea, dimethylsulphoxide, ethanol, ethyl acetate, ethyl benzene, ethylene glycol, ethyl amyl ketone, ethyl benzene, ethyl propionate, ethylene glycol diacetate, ethylene glycol monobutyl ether, ethylene glycol monoethyl ether, ethylene glycol monohexyl ether, ethylene glycol monomethyl ether, ethylene glycol monopropyl ether, fluorobenzene, formamide, furfural, heptane, hexane, hexylene glycol, hexylene glycol diacetate, iso-butyl acetate, iso-butyl isobutyrate, isoamyl alcohol, isobutanol, isopropanol, isopropyl acetate, 1,3,5-trimethylbenzene, methane sulphonic acid, methanol, methyl acetate, methyl cellosolve, methyl cyclohexane, methyl ethyl ketone, methyl amyl ketone, methyl amyl acetate, methyl hexyl ketone, methyl n-propyl ketone, methylene chloride, n-butyl propionate, n-heptyl acetate, n-hexyl acetate, n-nonyl acetate, n-octyl acetate, n-pentyl propionate, primary amyl acetate, propylene glycol monoethyl ether acetate, propylene glycol t-butyl ether, propylene glycol isobutyl ether, propylene glycol monobutyl ether, propylene glycol monothyl ether, propylene glycol monopropyl ether, methyl isobutyl ketone, methyl tertbutyl ether, m-xylene, n,n-dimethyl formamide, n,n-dimethylacetamide, N,N-dimethylaniline, n-butanol, n-propyl acetate, o-xylene, pentane, petroleum ether, propionic acid, p-xylene, pyridine, sec-butyl alcohol, sec-butyl acetate, tert-butyl alcohol, tetrachloroethylene, tetrahydrofuran, terpene, toluene, trichloroethylene, triethylamine, triethylene glycol monobutyl ether, triethylene glycol, monoethyl ether triethylene glycol, monomethyl ether, triethylene glycol diacetate, and a combination thereof; and

(B) mixing the solvent component with the binder component to form said composition.

### DETAILED DESCRIPTIONS

Unless stated otherwise:

These and other features and advantages of the present disclosure will be more readily understood, by those of ordinary skill in the art, from a reading of the following detailed description. It is to be appreciated those certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

The crosslinkable functionalities are chemically reactive functionalities provided on the back bone, at terminal end(s) or pendant from the backbone of a polymer chain. When a crosslinkable polymer is mixed with a crosslinking agent, crosslinkable functionalities on the crosslinkable polymer react with the crosslinking functionalities on the crosslinking agent to form a network, i.e., a process of curing that leads to the formation of a coating having the desired coating properties, such as high gloss, mar-resistance and resistance to environmental etching. Typical crosslinkable functionalities can include hydroxyl, acetoacetoxy, thiol, carboxyl, primary amine, secondary amine, epoxy, anhydride, imino, ketimine, and aldimine functionalities.

The crosslinking functionalities in a crosslinking component are chemically reactive functionalities provided on the back bone, at terminal end(s) or pendant from the backbone of a polymer chain, a compound, or an oligomer. When a crosslinking component is mixed with a crosslinkable component, crosslinkable functionalities react with the crosslinking functionalities to form a network. Typical crosslinking functionalities can include isocyanate, amine, ketimine, melamine, epoxy, polyacid, anhydride, and a combination thereof.

It would be clear to one of ordinary skill in the art that generally certain crosslinking functionalities from the crosslinking components crosslink with certain crosslinkable functionalities from the crosslinkable components. Some of those paired combinations include: (1) ketimine crosslinking functionalities generally crosslink with acetoacetoxy, epoxy, or anhydride crosslinkable functionalities; (2) isocyanate and melamine crosslinking functionalities generally crosslink with hydroxyl, thiol, primary and secondary amine, ketimine, or aldimine crosslinkable functionalities; (3) epoxy crosslinking functionalities generally crosslink with carboxyl, primary and secondary amine, ketimine, or anhydride crosslinkable functionalities; (4) amine crosslinking functionalities generally crosslink with acetoacetoxy crosslinkable functionalities; (5) polyacid crosslinking functionalities generally crosslink with epoxy crosslinkable functionalities; and (6) anhydride crosslinking functionalities generally crosslink with epoxy and ketimine crosslinkable functionalities.

“Two-pack coating composition” means a thermoset coating composition comprising a crosslinkable component and a crosslinking component that are stored in separate containers. These containers are typically sealed to increase the shelf life of the components of the composition. The crosslinkable component and crosslinking component are mixed prior to use to form a pot mix. The pot mix has a limited pot life, typically a few minutes (15 minutes to 45 minutes) to a few hours (4 hours to 6 hours). The pot mix is conventionally applied, generally by means of a spray gun or roller, as a layer of a desired thickness on a substrate surface, such as an autobody. After the application, the layer is cured under ambient conditions or bake cured at elevated temperatures to form a coating on the substrate surface having the desired coating properties, such as high gloss, mar-resistance and resistance to environmental etching.

“One-pack coating composition” means a thermoset coating composition comprising a crosslinkable component and a crosslinking component that are stored in the same container. However, crosslinkable functionalities on a crosslinkable polymer in the crosslinkable component are blocked to prevent premature crosslinking, i.e., curing. After the application of the one-pack coating composition on a substrate, the layer is typically exposed to elevated temperatures to unmask the blocked crosslinkable functionalities. Thereupon, the unmasked crosslinkable functionalities on the crosslinkable polymer in the layer react with the crosslinking functionalities on the crosslinking agent in the layer, which is bake-cured at elevated temperatures to form a coating on the substrate surface having the desired coating properties.

“Low VOC coating composition” means a coating composition that is less than about 0.6 kilogram of organic solvent per liter (4.8 pounds per gallon) of the composition, as determined under the procedure provided in ASTM D3960.

“GPC weight average molecular weight” and “GPC number average molecular weight” means a weight average molecular weight and a weight average molecular weight, respectively measured by utilizing gel permeation chromatography. A high performance liquid chromatograph (HPLC) supplied by Hewlett-Packard; Palo Alto, Calif. is typically used. Unless stated otherwise, the liquid phase used was tetrahydrofuran and the standard is typically polymethyl methacrylate.

The applicants have made an unexpected discovery that by including dimethyl carbonate, propylene carbonate or in combination with other co-solvents in a solvent borne composition, such as an automotive paint, it is possible to reduce the VOC of the composition without sacrificing the desired solvent properties, such as compatibility with other components in a composition, such as polymers in the binder component. The following embodiments are illustrative of the applicants' invention.

One embodiment of the coating composition of the present invention consists essentially of a binder component and a solvent component, wherein the solvent component consists of dimethyl carbonate, propylene carbonate or a combination thereof.

The proportion of dimethyl carbonate to propylene carbonate when used in combination in the solvent component ranges from 100/0 to 0/100, preferably from 100/0 to 80/20 and more preferably from 97/3 to 90/10.

It should be understood that commercially produced dimethyl carbonate or propylene carbonate can contain impurities or small quantities of other solvents, which are generally less than 0.5% weight percent based on the total of the dimethyl carbonate or propylene carbonate contained in the composition.

In another embodiment of the coating composition of the present invention consists essentially of a binder component and a solvent component, wherein the solvent component consists of:

(A) dimethyl carbonate; and

(B) a co-solvent selected from the group consisting of aromatic hydrocarbon (135-146C), aromatic hydrocarbon (150-190C), aromatic hydrocarbon (182-219C), aliphatic hydrocarbon (100-150C), aliphatic hydrocarbon (100-163C), aliphatic hydrocarbon (115-149C), aliphatic hydrocarbon (138-177C), aliphatic hydrocarbon (138-185C), aliphatic hydrocarbon (145-205C), aliphatic hydrocarbon (150-205C), aliphatic hydrocarbon (150-210C), aliphatic hydrocarbon (155-190C), aliphatic hydrocarbon (170-210C), aliphatic hydrocarbon (180-210C), aliphatic hydrocarbon (182-266C), aliphatic hydrocarbon (90-110C), mineral spirit, 1,1,1-trichloroethane, 1,1,2-trichloroethane, 1,2-propylene glycol, 1,3-butanediol, 1,4-butanediol, 1-butoxy ethoxy 222-propanol, 1-methyl naphthalene, 1-nitro propane, 2,4-pentane dione, 2-ethyl hexanol, 2-ethyl hexyl acetate, 2-methyl-1-butanol, acetic anhydride, butyl acetate, di-isoamyl ketone, diacetone alcohol, diethylene glycol, monobutyl ether acetate, diethylene glycol, diisobutyl ketone, ethylene glycol, monoethyl ether acetate, glycol monopropyl ether acetate benzyl alcohol, 1,2-dichloroethane, 1,3-dioxane, 1,2-dimethoxyethane, 1-butanol, 1-methyl-2-pyrrolidinone, 1-propanol, 2-butanol, 2-ethylhexanol, 2-methoxyethanol, 2-propanol, acetone, acetonitrile, benzene, bis(2-methoxyethyl)ether, butyl cellosolve, carbon tetrachloride, chlorobenzene, chlorobenzene, cyclohexane, cyclohexanol, cyclohexanone, dibasic ester, dichloromethane, diethyl ether, diethylene glycol monobutyl ether, diisopropyl ether, dimethyl ether, dimethylpropyleneurea, dimethylsulphoxide, ethanol, ethyl acetate, ethyl benzene, ethylene glycol, ethyl amyl ketone, ethyl benzene, ethyl propionate, ethylene glycol diacetate, ethylene glycol monobutyl ether, ethylene glycol monoethyl ether ethylene glycol monohexyl ether, ethylene glycol monomethyl ether, ethylene glycol monopropyl ether, fluorobenzene, formamide, furfural, heptane, hexane, hexylene glycol, hexylene glycol diacetate, iso-butyl acetate, iso-butyl isobutyrate, isoamyl alcohol, isobutanol, isopropanol, isopropyl acetate, 1,3,5-trimethylbenzene, methane sulphonic acid, methanol, methyl acetate, methyl cellosolve, methyl cyclohexane, methyl ethyl ketone, methyl amyl ketone, methyl amyl acetate, methyl hexyl ketone, methyl n-propyl ketone, methylene chloride, n-butyl propionate, n-heptyl acetate, n-hexyl acetate, n-nonyl acetate, n-octyl acetate, n-pentyl propionate, primary amyl acetate, propylene glycol monoethyl ether acetate, propylene glycol t-butyl ether, propylene glycol isobutyl ether, propylene glycol monobutyl ether, propylene glycol monothyl ether, propylene glycol monopropyl ether, methyl isobutyl ketone, methyl tertbutyl ether, m-xylene, n,n-dimethyl formamide, n,n-dimethylacetamide, N,N-dimethylaniline, n-butanol, n-propyl acetate, o-xylene, pentane, petroleum ether, propionic acid, p-xylene, pyridine, sec-butyl alcohol, sec-butyl acetate, t-butyl acetate, propylene carbonate, tert-butyl alcohol, tetrachloroethylene, tetrahydrofuran, terpene, toluene, trichloroethylene, triethylamine, triethylene glycol monobutyl ether, triethylene glycol, monoethyl ether triethylene, glycol monomethyl ether triethylene glycol diacetate, and a combination thereof.

The foregoing numerals in parenthesis, such as, for example, (90-110C) refer to an aromatic hydrocarbon having a boiling point range of 90° C. to 110° C.

Preferably, one or more co-solvents in the solvent component in the aforedescribed embodiment can be esters, ketones, ether alcohols, ether esters, alcohols, aromatic hyrocarbons, aliphatic hydrocarbons listed above, 1-methyl-2-pyrrolidinone, or a combination thereof.

More preferably, one or more co-solvents in the solvent component in the aforedescribed embodiment can be acetone, methyl propyl ketone, methyl amyl ketone, 2-propanol, 1-butanol, methoxy propanol, butoxyethanol, methyl acetate, ethyl acetate, propyl acetate, n-butyl acetate, t-butyl acetate, 2-ethyl hexyl acetate, methoxy propyl acetate, 1-methyl-2-pyrrolidinone, aromatic hydrocarbon (135-146C), aromatic hydrocarbon (150-190C), aromatic hydrocarbon (182-219C), heptane, aliphatic hydrocarbon (100-150C), aliphatic hydrocarbon (100-163C), aliphatic hydrocarbon (115-149C), aliphatic hydrocarbon (138-177C), aliphatic hydrocarbon (138-185C), aliphatic hydrocarbon (145-205C), aliphatic hydrocarbon (150-205C), aliphatic hydrocarbon (150-210C), aliphatic hydrocarbon (155-190C), or a combination thereof.

The solvent component in the aforedescribed embodiment consists in the range of 5 weight percent to 100 weight percent, preferably in the range of 10 to 90 and more preferably in the range of 40 to 80 of dimethyl carbonate, all percentages based on the total weight of the composition.

The solvent component in the aforedescribed embodiment consists in the range of 0.01 weight percent to 95 weight percent, preferably in the range of 15 to 90 and more preferably in the range of 20 to 60 of the co-solvent, all percentages based on the total weight of the composition.

The amount of solvent component in the foregoing embodiment of the composition can be adjusted to provide the composition with a VOC of less than 0.576 kilogram (4.8 pounds per gallon) and preferably in the range of 0.012 kilogram to 0.576 kilogram (0.1 pound to 4.8 pounds per gallon), more preferably in the range of from 0.12 kilogram to 0.42 kilogram (1.0 to 3.5 pounds per gallon), and most preferably in the range of from 0.012 kilogram to 0.252 kilogram (0.1 to 2.1 pounds per gallon) of solvent per liter of the composition. The solids level of the coating of the present invention varies in the range of from 5 percent to 100 percent, preferably in the range of from 10 percent to 95 percent and more, preferably in the range of from 25 percent to 85 percent, all percentages being based on the total weight of the composition.

The solvent component consists in the range of 0.01 weight percent to 95 weight percent, preferably in the range of 5 to 90 and more preferably in the range of 15 to 75 of dimethyl carbonate, propylene carbonate, or a combination thereof, all percentages based on the total weight of the composition.

The binder component in the compositions of the present invention can include a crosslinkable component and a crosslinking component, wherein the crosslinkable component includes one or more crosslinkable polymers having one to fifteen crosslinkable functionalities. The crosslinking component includes one or more crosslinking agents having two to six crosslinking functionalities.

Some suitable crosslinkable polymers are an acrylic polymer, polyester, polyurethane, polyether, polyvinylbutyral, polyvinylchloride, polyolefin, epoxy, silicone, vinyl ester, phenolic, alkyd or a combination thereof, all of which are typically provided with crosslinkable functionalities.

The binder component can include 0.1% to 50% by weight, based on the total weight of the binder component solids, of acrylic polymers. Some of the typical acrylic polymers include acrylic polymers which are the polymerization product of methacrylate, and acrylate monomers having weight average molecular weights ranging from 1,000 to 20,000. Styrene and other α,β ethylenically unsaturated monomers can also be used with the above monomers in the acrylic polymer.

Typical acrylic polymers are prepared by polymerizing a monomer mixture containing one or more following group of monomers, such as, for example, acrylic ester monomer including methyl acrylate, ethyl acrylate, butyl acrylate, 2-ethylhexyl acrylate, decyl acrylate, methyl methacrylate, ethyl methacrylate, butyl methacrylate, lauryl (meth)acrylate, isobornyl(meth)acrylate, isodecyl(meth)acrylate, oleyl(meth)acrylate, palmityl(meth)acrylate, stearyl(meth)acrylate, hydroxyethyl(meth)acrylate, and hydroxypropyl(meth)acrylate; acrylamide or substituted acrylamides; styrene or alkyl substituted styrenes; butadiene; ethylene; vinyl acetate; vinyl ester of “Versatic” acid (a tertiary monocarboxylic acid having C₉, C₁₀ and C₁₁ chain length, the vinyl ester is also known as “vinyl versataten), or other vinyl esters; vinyl monomers, such as, for example, vinyl chloride, vinylidene chloride, vinyl pyridine, N-vinyl pyrrolidone; amino monomers, such as, for example, N,N′-dimethylamino(meth)acrylate; chloroprene and acrylonitrile or methacrylonitrile. Acrylic acid, methacrylic acid, crotonic acid, itaconic acid, fumaric acid, maleic acid, monomethyl itaconate, monomethyl fumarate, monobutyl fumarate, maleic anhydride, 2-acrylamido-2-methyl-1-propanesulfonic acid, sodium vinyl sulfonate, and phosphoethyl methacrylate.

Preferably, the acrylic polymer is polymerized from a monomer mixture of about 5% to 30% by weight styrene, 10% to 40% by weight butyl methacrylate, 10% to 40% by weight butylacrylate, 15% to 50% by weight of hydroxyethyl acrylate or hydroxy propyl acrylate, all weight percentages based on the total weight of monomer solids. The acrylic polymer preferably has a weight average molecular weight of about 3,000 to 15,000. The acrylic polymer can be prepared by solution polymerization, typically at elevated temperatures, in which the monomer mixture, conventional solvents, thermal initiators, such as 2,2′-azobis(isobutyronitrile) or peroxy acetate, are heated to about 70° C. to 175° C. for about 1 to 12 hours.

The binder component of the coating composition of the present invention can contain from about 0.01% to 40% by weight of a polyester polymer which is the esterification product of an aliphatic or aromatic dicarboxylic acid, a polyol having at least three reactive hydroxyl groups, a diol, an aromatic or aliphatic cyclic anhydride and a cyclic alcohol. One preferred polyester is the esterification product of adipic acid, trimethylol propane, hexanediol, hexahydrophathalic anhydride and cyclohexane dimethylol. The weight percentages are based on total weight of the binder component solids.

Typically to prepare the aforedescribed polymers, a monomer mixture in conventional solvents polymerized, at elevated temperatures, with one or more conventional thermal initiators. Some of the suitable thermal initiators include 2,2′-azobis(2-methylpropanenitrile), 2,2′-azobis(2-methylbutanenitrile), 1,1′-azobis(cyclohexanecarbonitrile), tert-butyl peroxy-2-ethylhexanoate, tert-butylperoxydiethyl acetate, tert-butyl peroxyisobutyrate, 1,1-di-tert-butylperoxy-3,3,5-trimethylcyclohexane, 1,1-di-tert-butylperoxycyclohexane, tert-butyl peroxy-3,5,5-trimethylhexanoate, tert-butyl peroxyisopropyl carbonate, tert-butyl peroxyacetate, tert-butyl peroxybenzoate, dicumyl peroxide, tert-butyl cumyl peroxide, di-tert-butyl peroxide and di-tert-amyl peroxide.

As noted earlier, the aforedescribed crosslinkable acrylic polymers and polyesters are provided with one or more crosslinkable functionalities such as, hydroxy functionalities; or functionalities that can form hydroxy functionalities on hydrolysis, such as carbonate and orthoester, amine functionality; or groups that can form amine functionality on hydrolysis, such as ketimine, aldimine or oxazoline and any combination of such functional groups. Hydroxyl functionalities are preferred. At least one of the monomer in the monomer mixture provides the crosslinkable acrylic polymer or polyester with one or more crosslinkable functionalities. Alternatively, crosslinkable functionalities can also be provided by reacting the resulting polymer, after polymerization, with a monomer or a polymer that provides the resulting polymer with crosslinkable functionalities.

Some of the suitable crosslinking agents for the aforedescribed crosslinkable acrylic polymers and polyesters include polyisocyanates, melamines, urea formaldehyde polymers, or a combination thereof.

Suitable polyisocyanates have on an average 2 to 10, preferably 2.5 to 6 and more preferably 3 to 4 crosslinking functionalities, i.e., isocyanates. The composition can include in the range of from 0.01 percent to 70 percent, preferably in the range of from 10 percent to 50 percent, and more preferably in the range of 20 percent to 40 percent of the polyisocyanate, the percentages being in weight percentages based on the total weight of composition solids.

The following polyisocyanates are suitable:

Aliphatic polyisocyanates, which include aliphatic or cycloaliphatic di-, tri- or tetra-isocyanates, which may or may not be ethylenically unsaturated. such as 1,2-propylene diisocyanate, trimethylene diisocyanate, tetramethylene diisocyanate, 2,3-butylene diisocyanate, hexamethylene diisocyanate, octamethylene diisocyanate, 2,2,4-trimethyl hexamethylene diisocyanate, 2,4,4-trimethyl hexamethylene diisocyanate, dodecamethylene diisocyanate, omega-dipropyl ether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-viny-lidene diisocyanate, dicyclohexylmethane-4,4′-diisocyanate, 3,3′-dimethyl-dicyclohexylmethane 4,4′-diisocyanate, and meta-tetramethylxylylene diisocyanate. The polyisocyanates can include those having isocyanurate structural units, such as the isocyanurate of hexamethylene diisocyanate and isocyanurate of isophorone diisocyanate, the adduct of 2 molecules of a diisocyanate, such as hexamethylene diisocyanate, uretidiones of hexamethylene diisocyanate, uretidiones of isophorone diisocyanate or isophorone diisocyanate; and diols, such as ethylene glycol, the adduct of 3 molecules of hexamethylene diisocyanate and 1 molecule of water (available under the trademark Desmodur® N of Bayer Corporation, Pittsburgh, Pa.). The polyisocyanates can also include suitable aromatic polyisocyanates for use in coatings not requiring high levels of stability to UV light. Some of such suitable aromatic polyisocyanates can include toluene diisocyanate and diphenylmethane diisocyanate. If desired, the isocyanate functionalities of the polyisocyanate can be blocked with a monomeric alcohol to prevent premature crosslinking in a one-pack composition. Some of the suitable monomeric alcohols include methanol, ethanol, propanol, butanol, isopropanol, isobutanol, hexanol, 2-ethylhexanol and cyclohexanol.

The crosslinking component of the binder component when containing polyisocyanate can also contain a catalyst component, which preferably includes one or more catalysts to enhance crosslinking of during the curing. Suitable catalysts include one or more organo tin catalysts, such as dibutyl tin dilaurate, dibutyl tin diacetate, stannous octoate, and dibutyl tin oxide. Dibutyl tin dilaurate is preferred. The amount of organo tin catalyst added generally ranges from 0.001 percent to 0.5 percent, preferably from 0.05 percent to 0.2 percent and more preferably from 0.01 percent to 0.1 percent, the percentages being in weight percentages based on the total weight of composition solids.

The following melamines are suitable:

Monomeric or polymeric melamine-formaldehyde resin (melamine) or a combination thereof. The composition can include in the range of from 0.1 percent to 40%, preferably in the range of from 15% to 35%, and most preferably in the range of 20 percent to 30 percent of the melamine, the percentages being in weight percentages based on the total weight of composition solids. The monomeric melamines include low molecular weight melamines which contain, on an average, three or more methylol groups etherized with a C₁ to C₅ monohydric alcohol such as methanol, n-butanol, or isobutanol per triazine nucleus, and have an average degree of condensation up to about 2 and preferably in the range of about 1.1 to about 1.8, and have a proportion of mononuclear species not less than about 50 percent by weight. By contrast the polymeric melamines have an average degree of condensation of more than 1.9. Some such suitable monomeric melamines include alkylated melamines, such as methylated, butylated, isobutylated melamines and mixtures thereof. Many of these suitable monomeric melamines are supplied commercially. For example, Cytec Industries Inc., West Patterson, N.J. supplies Cymel® 301 (degree of polymerization of 1.5, 95% methyl and 5% methylol), Cymel® 350 (degree of polymerization of 1.6, 84% methyl and 16% methylol), 303, 325, 327 and 370, which are all monomeric melamines. Suitable polymeric melamines include high amino (partially alkylated, —N, —H) melamine known as Resimene® BMP5503 (molecular weight 690, polydispersity of 1.98, 56% butyl, 44% amino), which is supplied by Solutia Inc., St. Louis, Mo., or Cymel®1158 provided by Cytec Industries Inc., West Patterson, N.J. Cytec Industries Inc. also supplies Cymel® 1130 @ 80 percent solids (degree of polymerization of 2.5), Cymel® 1133 (48% methyl, 4% methylol and 48% butyl), both of which are polymeric melamines.

The crosslinking component of the binder component when containing melamine can also contain a catalyst component, which preferably includes one or more catalysts to enhance crosslinking of the components on curing. Generally, the coating composition includes in the range of from 0.1 percent to 5 percent, preferably in the range of from 0.1 to 2 percent, more preferably in the range of from 0.5 percent to 2 percent and most preferably in the range of from 0.5 percent to 1.2 percent of the catalyst, the percentages being in weight percentage based on the total weight of composition solids. Some suitable catalysts include the conventional acid catalysts, such as aromatic sulfonic acids, for example dodecylbenzene sulfonic acid, para-toluenesulfonic acid and dinonylnaphthalene sulfonic acid, all of which are either unblocked or blocked with an amine, such as dimethyl oxazolidine and 2-amino-2-methyl-1-propanol, n,n-dimethylethanolamine or a combination thereof. Other acid catalysts that can be used are strong acids, such as phosphoric acids, more particularly phenyl acid phosphate, which may be unblocked or blocked with an amine.

Some of the suitable urea formaldehyde polymers include methylated urea formaldehyde Resimene® 980 and butylated urea formaldehyde U-6329, which are supplied by Solutia Inc., St. Louis, Mo.

Some of the suitable crosslinking agents can also include a silane polymer or oligomer provided with at least one reactive silane group. The coating composition can include in the range of from 0.1% to 45%, preferably in the range of from 10% to 40%, and most preferably in the range of from of 15% to 35% of the silane polymer, the percentages being in weight percentages based on the total weight of composition solids. The silane polymers suitable for use in the present invention have weight average molecular weight in the range of about 500 to 30,000, preferably in the range of about 750 to 25,000 and more preferably in the range of about 1000 to 7,500. All molecular weights disclosed herein are determined by gel permeation chromatography using a polystyrene standard. The silane polymer suitable herein is a polymerization product of about 30 to 95%, preferably 40 to 60%, by weight of ethylenically unsaturated non-silane containing monomers and about 5 to 70%, preferably 40 to 60%, by weight of ethylenically unsaturated silane containing monomers, based on the weight of the silane polymer. Suitable ethylenically unsaturated non-silane containing monomers are: alkyl acrylates, alkyl methacrylates and any mixtures thereof, where the alkyl groups have 1 to 12 carbon atoms, preferably 3 to 8 carbon atoms.

In addition to alkyl acrylates or methacrylates, other polymerizable non-silane-containing monomers, up to about 50% by weight of the polymer, can be used in the silane polymer for the purpose of achieving the desired properties such as, hardness, appearance, and mar resistance. Exemplary of such other monomers are styrene, methyl styrene, acrylamide, acrylonitrile and methacrylonitrile. Styrene can be used in the range of 0.1 to 50%, preferably 5% to 30% by weight of the silane polymer. Typical examples of silane containing monomers for silane polymerization are the acrylatoalkoxy silanes, such as γ-macryloxypropyltrimethoxy silane and the methacrylatoalkoxy silanes, such as γ-methacryloxypropyltrimethoxy silane, and γ-methacryloxypropyltris(2-methoxyethoxy) silane. Other suitable alkoxy silane monomers are vinylalkoxy silanes, such as vinyltrimethoxy silane, vinyltriethoxy silane and vinyltris(2-methoxyethoxy) silane. Still other suitable silane containing monomers are acyloxysilanes, including acrylatoxy silane, methacrylatoxy silane and vinylacetoxy silanes, such as vinylmethyldiacetoxy silane, acrylatopropyltriacetoxy silane, and methacrylatopropyltriacetoxy silane. It is understood that combinations of the above-mentioned silane containing monomers are also suitable.

One preferred example of a silane polymer useful in the coating composition is polymerized from about 15 to 25% by weight styrene, about 30 to 60% by weight methacryloxypropyltrimethoxy silane, and about 25 to 50% by weight trimethylcyclohexyl methacrylate. Another preferred silane polymer contains about 30% by weight styrene, about 50% by weight methacryloxypropyltrimethoxy silane, and about 20% by weight of nonfunctional acrylates or methacrylates such as trimethylcyclohexyl methacrylate, butyl acrylate, and iso-butyl methacrylate and any mixtures thereof.

Silane functional monomers also can be used in forming the silane polymer. These monomers are the reaction product of a silane containing compound, having a reactive group such as epoxide or isocyanate, with an ethylenically unsaturated non-silane containing monomer having a reactive group, typically a hydroxyl, acid or an epoxide group, which is co-reactive with the silane monomer.

Suitable silane oligomers, such as 1-trimethoxysilyl-4-trimethoxysilylmethylcyclohexane, useful in the present coating composition include, but are not limited to, those taught in U.S. Pat. No. 5,527,936.

The crosslinking component of the binder component when containing silane can also contain a catalyst component, which preferably includes one or more catalysts to enhance crosslinking of the silane moieties of the silane polymer with itself and with other components of the composition. Typical of such catalysts are dibutyl tin dilaurate, dibutyl tin diacetate, dibutyl tin dioxide, dibutyl tin dioctoate, tin acetate, titanates such as tetraisopropyl titanate, tetrabutyl titanate (Tyzor® RTM supplied by DuPont Company, Wilmington, Del.), aluminum titanate, aluminum chelates, and zirconium chelate. Amines and acids, or combinations thereof, are also useful for catalyzing silane bonding. Preferably, these catalysts are used in the amount of about 0.1 to 5.0% by weight of the composition.

Some of the crosslinkable polymers suitable for the aforedescribed silane crosslinking agent include polymers and oligomers containing hydroxy functionality, or groups that can form hydroxy groups such as carbonate and orthoester, alkoxysilicates and any combination of such groups.

The crosslinking component can also include from about 0.1 to 40% by weight of an epoxy crosslinking agent containing at least two epoxy groups and having a molecular weight of less than about 2500. Some of the suitable epoxy crosslinker include sorbitol polyglycidyl ether, mannitol polyglycidyl ether, pentaerythritol polyglycidyl ether, glycerol polyglycidyl ether, low molecular weight epoxy resins, such as epoxy resins of epichlorohydrin and bisphenol-A, di- and polyglycidyl esters of polycarboxylic acids, polyglycidyl ethers of isocyanurates, such as DENECOL® EX301 polyglycidyl ether from Nagase in Japan; sorbitol polyglycidyl ether, such as DEC-358® polyglycidyl ether from Dixie Chemical in Texas, and di- and polyglycidyl esters of acids, such as ARALDITE® CY-184 polyglycidyl ester from Ciba-Geigy in New York, or XU-71950 polyglycidyl ester from Dow Chemical company in Michigan. Cycloaliphatic epoxies can also be used, such as ERL-4221 from Union Carbide.

The crosslinking component of the composition can include from about 0.1 to 40% by weight of an epoxy crosslinking agent containing at least two epoxy groups and having a molecular weight of less than about 2500. Some of the suitable epoxy crosslinking agents include sorbitol polyglycidyl ether, mannitol polyglycidyl ether, pentaerythritol polyglycidyl ether, glycerol polyglycidyl ether, low molecular weight epoxy resins, such as epoxy resins of epichlorohydrin and bisphenol-A, di- and polyglycidyl esters of polycarboxylic acids, polyglycidyl ethers of isocyanurates, such as DENECOL® EX301 polyglycidyl ether from Nagase in Japan; sorbitol polyglycidyl ether, such as DEC-358® polyglycidyl ether from Dixie Chemical in Texas, and di- and polyglycidyl esters of acids, such as ARALDITE® CY-184 polyglycidyl ester from Ciba-Geigy in New York, or XU-71950 polyglycidyl ester from Dow Chemical company in Michigan. Cycloaliphatic epoxies can also be used, such as ERL-4221 from Union Carbide.

The epoxy crosslinking agent containing composition preferably includes one or more catalysts to enhance crosslinking of the components on curing. Generally, the composition includes in the range of from 0.1 percent to 5 percent, preferably in the range of from 0.1 to 2 percent, more preferably in the range of from 0.5 percent to 2 percent and most preferably in the range of from 0.5 percent to 1.2 percent of the catalyst, the percentages being in weight percentage based on the total weight of composition solids. Some suitable catalysts include tertiary amines such as triethylene diamine, bis(2-dimethyl aminoethyl)ether and N,N,N¹,N¹-tetramethylethylenediamine and onium compounds including quaternary phosphonium and quaternary ammonium. Examples of phosphonium catalysts which can be used in catalyst blends are benzyl triphenyl phosphonium chloride; ethyl triphenyl phosphonium bromide; tetra butyl phosphonium chloride; tetra butyl phosphonium bromide; benzyl triphenyl phosphonium iodide; benzyl triphenyl phosphonium bromide; and ethyl triphenyl phosphonium iodide.

It should be generally understood that in the foregoing examples, ketimine crosslinking agent generally crosslinks with acetoacetoxy crosslinkable functionalities; polyisocyanate crosslinking agent generally crosslinks with hydroxyl, primary and secondary amine, and ketimine crosslinkable functionalities; epoxy crosslinking agent generally crosslinks with carboxyl, anhydride, primary and secondary amine crosslinkable groups; polyamine crosslinking agent generally crosslinks with acetoacetoxy, and epoxy crosslinkable functionalities; polyacid crosslinking agent generally crosslinks with epoxy crosslinkable functionalities; and Melamine crosslinking agents generally crosslink with hydroxyl, carboxyl, and amide crosslinkable functionalities.

The composition of the present invention can optionally contain, in the range of from 0.1 percent to 50 percent, a modifying resin, such as a well known non-aqueous dispersion (NAD), all percentages being based on the total weight of composition solids. The weight average molecular weight of the modifying resin generally varies in the range of from 20,000 to 100,000, preferably in the range of from 25,000 to 80,000 and more preferably in the range from 30,000 to 50,000.

In yet another embodiment, the binder component of the composition can contain a film forming polymer, which typically a high molecular weight thermoplastic polymer, which is dissolved in the solvent component. Such a composition is conventionally applied over a substrate and upon evaporation of the solvent component, a coating of the film forming polymer is then produced over the substrate

The composition of the present invention can also contain conventional additives, such as, pigments, UV absorbers, stabilizers, rheology control agents, flow agents, metallic flakes, toughening agents and fillers. Such additional additives will, of course, depend upon the intended use of the coating composition. Fillers, pigments, and other additives that would adversely affect the clarity of the cured coating are typically not included if the composition is intended as a clear coating.

To improve weatherability of the clear finish of the composition, about 0.1 to 5% by weight, based on the weight of the composition solids, of an ultraviolet light stabilizer or a combination of ultraviolet light stabilizers and absorbers may be added. These stabilizers include ultraviolet light absorbers, screeners, quenchers and specific hindered amine light stabilizers. Also, about 0.1 to 5% by weight, based on the weight of the composition solids, of an antioxidant can be added. Most of the foregoing stabilizers are supplied by Ciba Specialty Chemicals, Tarrytown, N.Y.

In use, the first-pack of the two-pack composition containing the crosslinkable component and other additives, and the second-pack containing the crosslinkable component are mixed just prior to use for about 1 to 15 minutes before use to form a pot mix, which has limited pot life, in range of from 5 minutes to 6 hours, before it becomes too viscous to permit application through conventional application systems, such as spraying. Alternatively, the first pack and the second pack are mixed together at the plural spray gun with or without electrostastics, before applied to a substrate. Other methods of applications include roller coating, dipping or brushing and other conventional application methods. The layer of the composition then cures under ambient conditions or preferably at higher temperatures in the range of 80° C.-160° C. for 10 minutes to 3 hours, preferably in the range of 20 minutes to 1 hour to form a coating on the substrate having the desired coating properties.

When the one-pack composition containing the blocked crosslinking agent is used, a layer thereof, applied over a substrate using aforedescribed application techniques, is cured at a baking temperature in the range of from 80° C.-200° C., preferably in the range of 80° C.-160° C., for about 10 to 60 minutes. It is understood that the actual baking temperature would vary depending upon the type of catalyst and the amount thereof is used, the thickness of the layer being cured, the blocked crosslinking functionalities and the type of crosslinking agent utilized in the composition. The use of the foregoing baking step is particularly useful under Original Equipment Manufature (OEM) condition.

It is further understood that the actual curing time depends upon the presence or absence of any suitable drying devices, such as, fans that assist in continuously flowing air over the coated substrate to accelerate the cure rate. Generally, a clearcoat layer having a thickness in the range of from 25 micrometers to 75 micrometers applied over a metal substrate, such as automotive body, which is often pre-coated with other coating layers, such as electro-coat, primer and basecoat, cures in 20 to 60 minutes at baking temperatures ranging from 80° C.-160° C.

In the alternative, the binder component of the composition can include one or more conventional photoinitiators. The layer of such a composition when exposed to actinic radiation, such as ultraviolet light, can trigger the crosslinking of the crosslinkable crosslinking functionalities in the applied layer to produce a coating on the substrate.

In another embodiment of the invention, the binder component of the composition can be a conventional thermoplastic polymer, such as a high molecular weight polymer, which is dissolved in the aforedescribed solvent component. A layer of such a composition can be conventionally applied over a substrate. Upon evaporation of the solvent component, a film of the thermoplastic polymer is formed over the substrate as a coating.

The compositions of the aforedescribed embodiments can be formulated as a coating composition, an adhesive, or a printing ink. The coating composition can be an automotive OEM paint, automotive refinish paint, architectural paint or an industrial paint.

The suitable substrates for applying the coating composition of the present invention include automobile bodies, any and all items manufactured and painted by automobile sub-suppliers, frame rails, commercial trucks and truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers, recreational vehicles, including but not limited to, motor homes, campers, conversion vans, vans, pleasure vehicles, pleasure craft snow mobiles, all terrain vehicles, personal watercraft, motorcycles, boats, and aircraft. The substrate further includes industrial and commercial new construction and maintenance thereof; cement and wood floors; leather; walls of commercial and residential structures, such office buildings and homes; amusement park equipment; concrete surfaces, such as parking lots and drive ways; asphalt and concrete road surface, wood substrates, marine surfaces; outdoor structures, such as bridges, towers; coil coating; railroad cars; printed circuit boards; machinery; OEM tools; signage; fiberglass structures; sporting goods; and sporting equipment.

This invention further directed to a process for producing a composition consisting essentially of a binder component and a solvent component. The process can comprise the steps of:

(A) preparing the solvent component by mixing a solvent dimethyl carbonate with a co-solvent selected from the group consisting of aromatic hydrocarbon (135-146C), aromatic hydrocarbon (150-190C), aromatic hydrocarbon (182-219C), aliphatic hydrocarbon (100-150C), aliphatic hydrocarbon (100-163C), aliphatic hydrocarbon (115-149C), aliphatic hydrocarbon (138-177C), aliphatic hydrocarbon (138-185C), aliphatic hydrocarbon (145-205C), aliphatic hydrocarbon (150-205C), aliphatic hydrocarbon (150-210C), aliphatic hydrocarbon (155-190C), aliphatic hydrocarbon (170-210C), aliphatic hydrocarbon (180-210C), aliphatic hydrocarbon (182-266C), aliphatic hydrocarbon (90-110C), mineral spirit, 1,1,1-trichloroethane, 1,1,2-trichloroethane, 1,2-propylene glycol, 1,3-butanediol, 1,4-butanediol, 1-butoxy ethoxy 222-propanol, 1-methyl naphthalene, 1-nitro propane, 2,4-pentane dione, 2-ethyl hexanol, 2-ethyl hexyl acetate, 2-methyl-1-butanol, acetic anhydride, butyl acetate, di-isoamyl ketone, diacetone alcohol, diethylene glycol monobutyl ether acetate, diethylene glycol, diisobutyl ketone, ethylene glycol monoethyl ether acetate, glycol monopropyl ether acetate benzyl alcohol, 1,2-dichloroethane, 1,3-dioxane, 1,2-dimethoxyethane, 1-butanol, 1-methyl-2-pyrrolidinone, 1-propanol, 2-butanol, 2-ethylhexanol, 2-methoxyethanol, 2-propanol, acetone, acetonitrile, benzene, bis(2-methoxyethyl)ether, butyl cellosolve, carbon tetrachloride, chlorobenzene, chlorobenzene, cyclohexane, cyclohexanol, cyclohexanone, dibasic ester, dichloromethane, diethyl ether, diethylene glycol monobutyl ether, diisopropyl ether, dimethyl ether, dimethylpropyleneurea, dimethylsulphoxide, ethanol, ethyl acetate, ethyl benzene, ethylene glycol, ethyl amyl ketone, ethyl benzene, ethyl propionate, ethylene glycol diacetate, ethylene glycol monobutyl ether, ethylene glycol monoethyl ether, ethylene glycol monohexyl ether, ethylene glycol monomethyl ether, ethylene glycol monopropyl ether, fluorobenzene, formamide, furfural, heptane, hexane, hexylene glycol, hexylene glycol diacetate, iso-butyl acetate, iso-butyl isobutyrate, isoamyl alcohol, isobutanol, isopropanol, isopropyl acetate, 1,3,5-trimethylbenzene, methane sulphonic acid, methanol, methyl acetate, methyl cellosolve, methyl cyclohexane, methyl ethyl ketone, methyl amyl ketone, methyl amyl acetate, methyl hexyl ketone, methyl n-propyl ketone, methylene chloride, n-butyl propionate, n-heptyl acetate, n-hexyl acetate, n-nonyl acetate, n-octyl acetate, n-pentyl propionate, primary amyl acetate, propylene glycol monoethyl ether acetate, propylene glycol t-butyl ether, propylene glycol isobutyl ether, propylene glycol monobutyl ether, propylene glycol monothyl ether, propylene glycol monopropyl ether, methyl isobutyl ketone, methyl tertbutyl ether, m-xylene, n,n-dimethyl formamide, n,n-dimethylacetamide, N,N-dimethylaniline, n-butanol, n-propyl acetate, o-xylene, pentane, petroleum ether, propionic acid, p-xylene, pyridine, sec-butyl alcohol, sec-butyl acetate, tert-butyl alcohol, tetrachloroethylene, tetrahydrofuran, terpene, toluene, trichloroethylene, triethylamine, triethylene glycol monobutyl ether, triethylene glycol, monoethyl ether triethylene glycol, monomethyl ether, triethylene glycol diacetate, and a combination thereof; and

(B) mixing the solvent component with the binder component to form said composition.

The composition can be produced as a coating composition, such as an automotive OEM paint, automotive refinish paint, architectural paint or an industrial paint; an adhesive; or a printing ink.

### Test Procedures

The following test procedures were used for generating data reported in the examples below:

USEPA Method 24 entitled as “Determination of Volatile Matter Content, Water Content, Density, Volume Solids, And Weight Solids Of Surface Coatings”. USEPA Method 24 was established by United States Environmental Protection Agency and is incorporated herein by reference.

### Examples

TABLE 1

| | | Comparative |
|---|---|---|
| Composition ingredients | Example 1 | Example 1 |
| Crosslinkable component | | |
| Crosslinkable Polymer¹ | 37.7 | 37.7 |
| Additive² (Provide chemical | 0.1 | 0.1 |
| name) | | |
| Hindered amine light | 0.6 | 0.6 |
| stabilizer³ | | |

Solvent component added
to crosslinkable component

| | | |
|---|---|---|
| n-propyl acetate | 0 | 40.3 |
| Dimethyl carbonate⁴ | 40.3 | |
| (Aldrich) | | |

Crosslinking component

| | | |
|---|---|---|
| Polyisocyanate⁵ | 20.7 | 20.7 |
| Total | 100 | 100 |
| Weight % Solids | 59.7 | 59.7 |
| VOC by EPA Method 24 | 0* | 3.5 |

¹Joncryl ® 587 hydroxy-functional acrylic copolymer, supplied by BASF Corporation, Sturtevant, Wisconsin.
²Modaflow ® acrylic flow and levelling agent, supplied Cytec Surface Specialties, Stamford, Connecticut.
³Tinuvin ® 292 Bis (1,2,2,6,6-pentamethyl piperidyl) sebacate, supplied Ciba Chemicals, Ardsley, New York.
⁴Supplied by Aldrich Chemicals, city name, state name.
⁵Tolonate ® HDT mixture of isocyanurate oligomers of 1,6-diisocyanatohexane, supplied Rhodia Inc., Cranbury, New Jersey.
*On the basis of the application filed by Kowa American Corporation, New York, New York on Jul. 29, 2004 to United States Environmental Protection Agency to make dimethyl carbonate as a VOC exempt solvent, said application being incorporated herein by reference.

The forgoing results obtained by using EPA Method 24 clearly show elimination of VOC obtained by using dimethyl carbonate.

TABLE 2

| | | Comparative |
|---|---|---|
| Composition ingredients | Example 2 | Example 2 |
| Crosslinkable component | | |
| Crosslinkable Polymer¹ | 37.7 | 37.7 |
| Additive² | 0.1 | 0.1 |
| Hindered amine light | 0.6 | 0.6 |
| stabilizer³ | | |
| UV Absorber⁴ | 0.6 | 0.6 |

Solvent component added
to crosslinkable component

| | | |
|---|---|---|
| n-propyl acetate | 0 | 22.7 |
| Dimethyl carbonate⁵ | 22.7 | |
| Methyl Amyl Ketone⁶ | 13.2 | 13.2 |
| 2-ethyl hexyl acetate | 4.4 | 4.4 |

Crosslinking component

| | | |
|---|---|---|
| Polyisocyanate⁷ | 20.7 | 20.7 |
| Total | 100 | 100 |
| Weight % Solids | 59.7 | 59.7 |
| VOC by EPA Method 24 | 2.1* | 3.5 |

¹Joncryl ® 587 hydroxy-functional acrylic copolymer, supplied by BASF Corporation, Sturtevant, Wisconsin.
²Modaflow ® acrylic flow and levelling agent, supplied Cytec Surface Specialties, Stamford, Connecticut.
³Tinuvin ® 292 Bis (1,2,2,6,6-pentamethyl piperidyl) sebacate, supplied Ciba Chemicals, Ardsley, New York.
⁴Tinuvin ® 328 2-(2-H-benzotriazol-2-yl) 4,6-ditertpentylphenol, supplied Ciba Chemicals, city name, state name.
⁵Supplied by Aldrich Chemicals in Milwaukee, Wisconsin.
⁶Supplied by Eastman Chemicals, Kingsport, Tennessee.
⁷Tolonate ® HDT mixture of isocyanurate oligomers of 1,6-diisocyanatohexane, supplied Rhodia Inc., Cranbury, New Jersey.
*On the basis of the application filed by Kowa American Corporation, New York, New York on Jul. 29, 2004 to United States Environmental Protection Agency to make dimethyl carbonate as a VOC exempt solvent, said application being incorporated herein by reference.

The forgoing results obtained by using EPA Method 24 clearly show reduction of VOC obtained by using dimethyl carbonate.

What is claimed is:

1. A process for producing a composition consisting essentially of a binder component and a solvent component, said process comprising the steps of:
(A) preparing the solvent component by mixing a solvent dimethyl carbonate with a co-solvent selected from the group consisting of aromatic hydrocarbon (135-146C), aromatic hydrocarbon (150-190C), aromatic hydrocarbon (182-219C), aliphatic hydrocarbon (100-150C), aliphatic hydrocarbon (100-163C), aliphatic hydrocarbon (115-149C), aliphatic hydrocarbon (138-177C), aliphatic hydrocarbon (138-185C), aliphatic hydrocarbon (145-205C), aliphatic hydrocarbon (150-205C), aliphatic hydrocarbon (150-210C), aliphatic hydrocarbon (155-190C), aliphatic hydrocarbon (170-210C), aliphatic hydrocarbon (180-210C), aliphatic hydrocarbon (182-266C), aliphatic hydrocarbon (90-110C), mineral spirit, 1,1,1-trichloroethane, 1,1,2-trichloroethane, 1,2-propylene glycol, 1,3-butanediol, 1,4-butanediol, 1-butoxy ethoxy 222-propanol, 1-methyl naphthalene, 1-nitro propane, 2,4-pentane dione, 2-ethyl hexanol, 2-ethyl hexyl acetate, 2-methyl-1-butanol, acetic anhydride, butyl acetate, di-isoamyl ketone, diacetone alcohol, diethylene glycol monobutyl ether acetate, diethylene glycol, diisobutyl ketone, ethylene glycol monoethyl ether acetate, glycol monopropyl ether acetate benzyl alcohol, 1,2-dichloroethane, 1,3-dioxane, 1,2-dimethoxyethane, 1-butanol, 1-methyl-2-pyrrolidinone, 1-propanol, 2-butanol, 2-ethylhexanol, 2-methoxyethanol, 2-propanol, acetone, acetonitrile, benzene, bis(2-methoxyethyl)ether, butyl cellosolve, carbon tetrachloride, chlorobenzene, chlorobenzene, cyclohexane, cyclohexanol, cyclohexanone, dibasic ester, dichloromethane, diethyl ether, diethylene glycol monobutyl ether, diisopropyl ether, dimethyl ether, dimethylpropyleneurea, dimethylsulphoxide, ethanol, ethyl acetate, ethyl benzene, ethylene glycol, ethyl amyl ketone, ethyl benzene, ethyl propionate, ethylene glycol diacetate, ethylene glycol monobutyl ether, ethylene glycol monoethyl ether, ethylene glycol monohexyl ether, ethylene glycol monomethyl ether, ethylene glycol monopropyl ether, fluorobenzene, formamide, furfural, heptane, hexane, hexylene glycol, hexylene glycol diacetate, iso-butyl acetate, iso-butyl isobutyrate, isoamyl alcohol, isobutanol, isopropanol, isopropyl acetate, 1,3,5-trimethylbenzene, methane sulphonic acid, methanol, methyl acetate, methyl cellosolve, methyl cyclohexane, methyl ethyl ketone, methyl amyl ketone, methyl amyl acetate, methyl hexyl ketone, methyl n-propyl ketone, methylene chloride, n-butyl propionate, n-heptyl acetate, n-hexyl acetate, n-nonyl acetate, n-octyl acetate, n-pentyl propionate, primary amyl acetate, propylene glycol monoethyl ether acetate, propylene glycol t-butyl ether, propylene glycol isobutyl ether, propylene glycol monobutyl ether, propylene glycol monothyl ether, propylene glycol monopropyl ether, methyl isobutyl ketone, methyl tertbutyl ether, m-xylene, n,n-dimethyl formamide, n,n-dimethylacetamide, N,N-dimethylaniline, n-butanol, n-propyl acetate, o-xylene, pentane, petroleum ether, propionic acid, p-xylene, pyridine, sec-butyl alcohol, sec-butyl acetate, tert-butyl alcohol, tetrachloroethylene, tetrahydrofuran, terpene, toluene, trichloroethylene, triethylamine, triethylene glycol monobutyl ether, triethylene glycol, monoethyl ether triethylene glycol, monomethyl ether, triethylene glycol diacetate, and a combination thereof; and
(B) mixing the solvent component with the binder component to form said composition.

2. The process of claim 1, wherein said co-solvent is selected from the group consisting of acetone, methyl propyl ketone, methyl amyl ketone, 2-propanol, 1-butanol, methoxy propanol, butoxyethanol, methyl acetate, ethyl acetate, propyl acetate, n-butyl acetate, t-butyl acetate, 2-ethyl hexyl acetate, methoxy propyl acetate, 1-methyl-2-pyrrolidinone, aromatic hydrocarbon (135-146C), aromatic hydrocarbon (150-190C), aromatic hydrocarbon (182-219C), heptane, aliphatic hydrocarbon (100-150C), aliphatic hydrocarbon (100-163C), aliphatic hydrocarbon (115-149C), aliphatic hydrocarbon (138-177C), aliphatic hydrocarbon (138-185C), aliphatic hydrocarbon (145-205C), aliphatic hydrocarbon (150-205C), aliphatic hydrocarbon (150-210C), aliphatic hydrocarbon (155-190C), and a combination thereof.

3. The process of claim 1, wherein said solvent component consists in the range of 5 weight percent to 100 weight percent of dimethyl carbonate, all percentages based on the total weight of the composition.

4. The process of claim 1, wherein said solvent component consists in the range of 0.01 weight percent to 95 weight percent of said co-solvent, all percentages based on the total weight of the composition.

5. The process of claim 1, wherein said binder component comprises a crosslinkable component and a crosslinking component, wherein said crosslinkable component comprises one or more crosslinkable polymers having one or more crosslinkable groups; and wherein said crosslinking component comprises one or more crosslinking agents having two or more crosslinking groups.

6. The process of claim 5, wherein said binder component comprises a catalyst component.

7. The process of claim 6, wherein said catalyst component consists essentially of one or more organo zinc catalysts, one or more organo tin catalysts, and one or more C₁ to C₈ carboxylic acids.

8. The process of claim 5, wherein a portion of said solvent component is included in said crosslinkable component and remainder of said solvent component is included in said crosslinking component.

9. The process of claim 5, wherein said binder component comprises pigments, UV absorbers, stabilizers, rheology control agents, flow agents, metallic flakes, toughening agents, fillers, or a combination thereof.

10. The process of claim 5, wherein said composition is formulated as a two-pack composition wherein said crosslinkable component is stored separately from said crosslinking component.

11. The process of claim 5, wherein said composition is formulated as a one-pack composition wherein said crosslinking groups are blocked.

12. The process of claim 1, 2, 3, 4, 5, 6, 7, 8, 9, 10, or 11, wherein said composition is formulated as a coating composition, an adhesive, or a printing ink.

14. The process of claim 13, wherein said coating composition is an automotive OEM paint, automotive refinish paint, architectural paint or an industrial paint.

15. The process of claim 1, 2, 3 or 4, wherein said binder component comprises one or more film forming polymers.

16. The process of claim 15, wherein said binder component comprises pigments, UV absorbers, stabilizers, rheology control agents, flow agents, metallic flakes, toughening agents, fillers, or a combination thereof.

17. The process of claim 16, wherein said composition is formulated as a coating composition, an adhesive, or a printing ink.

18. The process of claim 17 wherein said coating composition is an automotive OEM paint, automotive refinish paint, architectural paint or an industrial paint.
